(19) United States
(12) Patent Application Publication
(10) Pub. No.: US 2023/0061580 A1
(43) Pub. Date: Mar. 2, 2023

(54) METHOD FOR MANUFACTURING POROUS STRUCTURE FOR LITHIUM BATTERIES AND POROUS STRUCTURE FOR LITHIUM BATTERIES MANUFACTURED THEREBY

(71) Applicants: HYUNDAI MOTOR COMPANY, Seoul (KR); KIA CORPORATION, Seoul (KR); Kwangju Institute of Science and Technology, Gwangju (KR)

(72) Inventors: Jae Wook Shin, Uiwang-si (KR); Jong Chang Song, Uiwang-si (KR); Seong Min Ha, Uiwang-si (KR); Seung Jong Lee, Uiwang-si (KR); Won Keun Kim, Uiwang-si (KR); Kyoung Han Ryu, Uiwang-si (KR); Kwang Sup Eom, Gwangju (KR); Ha Yong Song, Gwangju (KR); Da In Seok, Gwangju (KR); Jin Hyeon Jo, Gwangju (KR)

(73) Assignees: Hyundai Motor Company, Seoul (KR); Kia Corporation, Seoul (KR); Kwangju Institute of Science and Technology, Gwangju (KR)

(21) Appl. No.: 17/898,974

(22) Filed: Aug. 30, 2022

(30) Foreign Application Priority Data
Aug. 31, 2021 (KR) 10-2021-0115335

(51) Int. Cl. H01M 4/80; H01M 10/052; H01M 4/38

(52) U.S. Cl. CPC H01M 4/801; H01M 10/052; H01M 4/382; H01M 2004/027

(57) ABSTRACT

Disclosed are a method for manufacturing a porous structure for lithium batteries, a porous structure for lithium batteries manufactured thereby, an anode for lithium batteries including the porous structure for lithium batteries, and a lithium battery including the same.

### CROSS-REFERENCE TO RELATED APPLICATION

This application claims under 35 U.S.C. § 119(a) the benefit of priority to Korean Patent Application No. 10-2021-0115335 filed on Aug. 31, 2021, the entire contents of which are incorporated herein by reference.

### TECHNICAL FIELD

The present disclosure relates to a method for manufacturing a porous structure for lithium batteries, the porous structure manufactured thereby, an anode including the porous structure, and a lithium battery including the anode.

### BACKGROUND

Research and development of energy storage and conversion apparatuses using sustainable eco-friendly energy and electrochemical mechanisms are being on the rise, as fossil fuels are rapidly exhausted, environmental pollution is accelerated and energy demand increases. Thereamong, a lithium battery is an excellent energy conversion apparatus having a high energy density and power density, and is used as a core part not only of a small electronic device but also of an eco-friendly electric vehicle, thus having the potential to replace a conventional internal combustion engine.

Lithium metal is a next-generation anode material for lithium batteries having high conductivity and capacity, but may cause shortening of the lifespan of a lithium battery due to problems, such as short-circuit of a cell, formation of a solid electrolyte interphase (SEI) layer on a lithium surface every cycle, dead lithium formation, etc., due to electrodeposition of lithium in the form of dendrites during the charging and discharging process.

Therefore, a solution that distributes a current density and a nucleation position by securing a wide electrochemically active surface area using a porous structure has been suggested.

However, the capacity of the porous structure per weight or volume is low due to low porosity and the high weight of the porous structure, it is difficult to accurately control the pore size, surface area and electrical characteristics of the structure, and thus, difficulty in effectively suppressing dendrite growth still exists.

In order to improve such a porous structure, manufacture of a porous structure which may freely adjust porosity, pore size, surface area, thickness, electrical characteristics, etc. is required. However, conventional carriers manufactured through a top-down approach using metal foil, mesh, foam, etc., cause difficulty in minutely controlling porosity, etc. And conventional method is too complicated to accurately implement a pore size of hundreds of nanometers or to implement high porosity, and thereof, technology for manufacturing a carrier which substantially improves performance of a lithium metal anode has not yet been developed.

Further, the mesh or the foam with very high conductivity has low material transport resistance on its surface, electrodeposited lithium is concentrated on the surface of it rather than pores therein. Therefore, it is difficult to suppress volume expansion of the electrode and formation of lithium dendrites.

Therefore, a method for manufacturing a porous structure for lithium batteries which may improve lifespan and performance of the porous structure in a new way while solving the above-described problems is required.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to provide a method for manufacturing a bottom-up-type porous structure for lithium batteries, which includes preparing a precursor by mixing first nanoparticles, second nanoparticles, which are organic or inorganic, and a binder, performing heat treatment of the precursor to weld the first nanoparticles, and etching the second nanoparticles in the heat-treated precursor.

It is another object of the present disclosure to provide a porous structure for lithium batteries including specific porosity and particle size manufactured by the above-described method, an anode for lithium batteries including the porous structure for lithium batteries, and a lithium battery employing the anode.

In one aspect, the present disclosure provides a method for manufacturing a porous structure for lithium batteries, the method including preparing a precursor by mixing first nanoparticles and second nanoparticles, heat-treating the precursor, and etching the second nanoparticles in the heat-treated precursor.

In a preferred embodiment, in the preparing the precursor, the precursor may be prepared by additionally mixing a binder with the first nanoparticles and the second nanoparticles.

In another preferred embodiment, an amount of the binder may range from about 3 wt % to about 50 wt % based on the total amount of the precursor.

In still another preferred embodiment, the method may further include preparing a precursor sheet by calendaring the precursor, after the preparing the precursor.

In yet another preferred embodiment, the first nanoparticles may include, but is not limited to, a lithiophilic material, a conductive metal or both of them.

In still yet another preferred embodiment, the lithiophilic material may include, but is not limited to, at least one of silver (Ag), zinc (Zn), gold (Au), aluminum (Al), magnesium (Mg), tin (Sn), silicon (Si), carbon (C) or any combination thereof.

In a further preferred embodiment, the conductive metal may include, but is not limited to, at least one of copper (Cu), iron (Fe), titanium (Ti), nickel (Ni) or any combination thereof.

In another further preferred embodiment, a mass ratio of the first nanoparticles to the second nanoparticles may range from about 1:0.3 to about 1:1.2.

In still another further preferred embodiment, the second nanoparticles may include, but is not limited to, organic nanoparticles, inorganic nanoparticles or both of them.

In yet another further preferred embodiment, the organic nanoparticles may include, but is not limited to, at least one of poly(methyl methacrylate), polyethylene oxide, cellulose, polystyrene or any combination thereof.

In still yet another further preferred embodiment, the inorganic nanoparticles may include, but is not limited to, at least one of silica (SiO₂), titania (TiO₂), zirconia (ZrO₂), alumina (Al₂O₃) or any combination thereof.

In a still further preferred embodiment, in the heat-treating the precursor, the metal nanoparticles may be welded by heat-treating the precursor at a heating rate of 30° C./min or less to a temperature of 240° C. to 260° C. from room temperature.

In a yet still further preferred embodiment, in the etching the second nanoparticles, the second nanoparticles may be removed by treating the heat-treated precursor using an acid solution.

In yet still another preferred embodiment, the acid solution may include, but is not limited to, hydrofluoric acid (HF) and at least one of methyl alcohol, ethyl alcohol, isopropyl alcohol, or any combination thereof.

In another aspect, the present disclosure provides a porous structure for lithium batteries including first nanoparticles, and having a porosity of about 30% to about 90%.

In a preferred embodiment, a pore size of the porous structure for lithium batteries may range from about 300 nm to about 5000 nm.

In another preferred embodiment, a thickness of the porous structure for lithium batteries may range from about 10 μm and about 100 μm.

In still another aspect, the present disclosure provides an anode for lithium batteries comprising lithium metal disposed on the porous structure.

In a further aspect, the present disclosure provides a lithium battery comprising the anode.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1A and 1B show charge and discharge efficiency analysis results of porous structures according to Preparation Example 1 (FIG. 1A) and Comparative Preparation Example 1 (FIG. 1B) of the present disclosure;

FIGS. 2A and 2B show Scanning Electron Microscope (SEM) images to the surface of the porous structures according to Preparation Example 1 (FIG. 2A) and Comparative Preparation Example 1 (FIG. 2B) during charging and discharging;

FIGS. 3A and 3B show SEM images to the cross-section of the porous structures according to Preparation Example 1 (FIG. 3A) and Comparative Preparation Example 1 (FIG. 3B) during charging and discharging of the present disclosure;

FIG. 4 shows coulombic efficiency analysis results of the porous structures according to Preparation Example 1, Preparation Example 2 and Comparative Preparation Example 1 of the present disclosure;

FIG. 5 shows capacity retention rates of lithium batteries according to Example 1 and Comparative Example 1 of the present disclosure, after the lithium batteries have been charged and discharged at a current density of 1 mA cm⁻², and

FIGS. 6, 7 and 8 are optical microscopic images showing degrees of electrodeposition of lithium in lithium batteries according to Comparative Example 2 (FIG. 6), Comparative Example 3 (FIG. 7) and Example 1 (FIG. 8) depending on time, after the lithium batteries have been charged and discharged at a current density of 1 mA cm⁻² of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure and methods for achieving the same will become apparent from the descriptions of embodiments given herein below with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends given herein are approximations in which various uncertainties in measurement generated when these values are acquired from essentially different things are reflected and thus, it will be understood that they are modified by the term “about”, unless stated otherwise. Whether or not modified by the term “about”, the claims include equivalents to the quantities. Unless otherwise stated or otherwise evident from the context, the term “about” may mean within XX % above or below the numerical value (except where such number would exceed 100% of a possible value or go below 0%) or a plus/minus manufacturing/measurement tolerance of the numerical value. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

In the following description of the embodiments, it will be understood that, when the range of a variable is stated, the variable includes all values within the stated range including stated end points of the range. For example, it will be understood that a range of “about 5 to 10” includes not only values of 5, 6, 7, 8, 9 and 10 but also arbitrary subranges, such as a subrange of about 6 to 10, a subrange of about 7 to 10, a subrange of about 6 to 9, and a subrange of about 7 to 9, and arbitrary values between integers which are valid within the scope of the stated range, such as 5.5, 6.5, 7.5, 5.5 to 8.5, and 6.5 to 9. Further, for example, it will be understood that a range of “about 10% to 30%” includes not only all integers including values of 10%, 11%, 12%, 13%, . . . 30% but also arbitrary subranges, such as a subrange of about 10% to 15%, a subrange of about 12% to 18%, and a subrange of about 20% to 30%, and arbitrary values between integers which are valid within the scope of the stated range, such as 10.5%, 15.5%, and 25.5%.

Lithium metal used in the anode of the conventional lithium battery causes shortening of the lifespan of the battery due to problems, such as short-circuit of a cell dead lithium formation, etc., due to electrodeposition of lithium in the form of dendrites during the charging and discharging process, and thus, a solution that distributes a current density and a nucleation position by securing a wide electrochemically active surface area using a porous structure has been suggested.

However, the conventional carriers are manufactured through a top-down approach using metal foil, mesh, foam, etc., and thus cause difficulty in minutely controlling conventional corresponding factors and complication in the manufacturing methods thereof, it is difficult to accurately implement a pore size of hundreds of nanometers or to implement high porosity, and thus, technology for manufacturing a carrier which substantially improves performance of a lithium metal anode has not yet been developed. Further, the mesh or the foam having very high conductivity has the lowest composite resistance including material transport resistance on the surface of an electrode, and thus, lithium electrodeposition is concentrated on the surface of the electrode rather than pores therein, and it is difficult to suppress increase in the thickness of the electrode and formation of lithium dendrites.

Therefore, a method for manufacturing a porous structure for lithium batteries which may improve lifespan and performance in a new way while solving the above-described problems is required.

Accordingly, as results of research, inventors of the present disclosure have found that a porous structure for lithium batteries manufactured by a method for manufacturing a bottom-up-type porous structure for lithium batteries, including preparing a precursor by mixing first nanoparticles, second nanoparticles which are organic or inorganic, and a binder, performing heat treatment of the precursor to weld the first nanoparticles, and etching the second nanoparticles in the heat-treated precursor, may accurately controlling not only microstructures, such as porosity, pore size and surface area of the structure, but also macrostructures, such as the thickness and area of an electrode, may adjust physical properties, such as conductivity and lithium affinity, and may thus accurately implement a pore size of hundreds of nanometers or implement high porosity, and consequently, an anode for lithium batteries including a porous structure for lithium batteries manufactured by this method may suppress growth of lithium in the form of dendrites, or may suppress thickness change due to induction of electrodeposition of lithium within pores, and thus, have complete the present disclosure.

A manufacturing method of a porous structure for lithium batteries according to the present disclosure is executed through welding and etching processes through a bottom-up approach. Specifically, the method comprises preparing a precursor by mixing first nanoparticles, second nanoparticles and a binder, performing heat treatment of the precursor to weld the first nanoparticles, and etching the second nanoparticles in the heat-treated precursor. The term of “the heat-treated precursor” may mean resultant of heat treatment to the precursor.

The term of “the bottom-up approach” may mean a manufacturing method in which copper particles having predetermined size, silica particles and a binder are mixed, a welding process is performed to form electrical contact between the copper particles, and then the silica particles are etched. That is, the present disclosure provides the porous structure for lithium batteries manufactured through the bottom-up approach, instead of the conventional top-down approach, and thus, characteristics of materials, such as pore size, porosity, conductivity, etc., may be more accurately controlled.

In preparation of the precursor, the precursor may be prepared by mixing the first nanoparticles and the second nanoparticles.

Here, the first nanoparticles are a material which forms the frame of the porous structure. The first nanoparticles may include a lithiophilic material, a conductive metal or both of them. As the first nanoparticles comprises the lithiophilic material and/or the conductive metal, the electrochemically active area of an electrode may be increased, thus being capable of suppressing concentration of current.

Particularly, the lithiophilic material may include, but is not limited to, at least one of silver (Ag), zinc (Zn), gold (Au), aluminum (Al), magnesium (Mg), tin (Sn), silicon (Si), carbon (C) or any combination thereof.

Further, the conductive metal may include, but is not limited to, at least one of copper (Cu), iron (Fe), titanium (Ti), nickel (Ni) or any combination thereof.

The second nanoparticles are particles which are removed during the subsequent etching process so as to form pores. Specifically, the second nanoparticles may include organic nanoparticles, inorganic nanoparticles or both of them which are capable of being etched using an acid solution. Particularly, the pore size of the porous structure may be adjusted by controlling the size of the second nanoparticles.

Particularly, the organic nanoparticles may include, but is not limited to, at least one of poly(methyl methacrylate), polyethylene oxide, cellulose, polystyrene or any combination thereof. The inorganic nanoparticles may include, but is not limited to, at least one of silica (SiO₂), titania (TiO₂), zirconia (ZrO₂), alumina (Al₂O₃) or any combination thereof.

Here, the porosity of the porous structure may be also adjusted by controlling the mass ratio of the first nanoparticles to the second nanoparticles. Specifically, the mass ratio of the first nanoparticles to the second nanoparticles may range from about 1:0.3 to about 1:1.2, preferably about 1:0.5 to about 1:1. When the mass of the second nanoparticles is excessively low beyond the above range, a space in which lithium may be electrodeposited is small, the weight of the porous structure is heavy, and thus, energy density and specific energy are reduced and, when the mass of the second nanoparticles is excessively high, porosity is excessively increased and thus the mechanical properties of the porous structure are reduced.

Further, in preparation of the precursor, the precursor may be prepared by additionally mixing the binder with the first nanoparticles and the second nanoparticles. Here, the additionally mixed binder may improve the binding force of the first nanoparticles, and the binder, which is properly added to the porous structure, may relatively reduce the conductivity of the porous structure so that lithium can be electrodeposited within the porous structure during charging and discharging of the lithium battery, thereby being capable of suppressing growth of lithium dendrites and volume expansion of the porous structure.

The binder may include, but is not limited to, at least one of polyterafluoethylene (PTFE), polyethylene oxide (PEO), polyacrylic add (PAA), polyacrylonitrile (PAN), polyvinyl alcohol (PVA), polyvinylidene fluoride (PVF) or any combination thereof.

Particularly; an amount of the binder may range from about 3 wt % to about 50 wt %, preferably about 5 wt % to about 20 wt % based on the total amount of the precursor. When the amount of the binder is excessively low beyond the above range, the conductivity of the electrode is excessively high and thus surface electrodeposition of lithium is predominant, and mechanical strength of the electrode is reduced and, when the amount of the binder is excessively high, the resistance of the electrode is increased and thus overvoltage is increased.

Further, the method for manufacturing the porous structure may further include preparing a precursor sheet by calendaring the precursor, after preparation of the precursor. Thereby, the macrostructures of the porous structure may be minutely controlled.

A calendaring process may be performed at a temperature of about 30° C. or lower so as to form the precursor sheet having a thickness of about 20 to about 80 μm. When the temperature is excessively high beyond the above temperature range, the electrode is dried during the calendaring process and thus a crack may occur, when the thickness of the precursor sheet is excessively large, the energy density of the lithium battery is reduced and, when the thickness of the precursor sheet is excessively small, the areal capacity of the electrode is not satisfied.

After the precursor has been prepared, heat treatment of the precursor is performed to weld the first nanoparticles so as to improve binding force therebetween. As the binding force is improved, the conductivity and mechanical strength of the electrode are increased.

Specifically, in heat treatment of the precursor, the precursor may be heat-treated by raising the temperature from room temperature to about 240° C. to about 260° C. at a heating rate of about 30° C./min so that the first nanoparticles are welded each other. The room temperature may range from about 20° C. to about 30° C., preferably may be 25° C. When the heat treatment temperature is excessively low beyond the above temperature range, fusion between the first nanoparticles does not occur and thus electrical connection therebetween does not occur, and the mechanical strength of the electrode is reduced and, when the heat treatment temperature is excessively high, the binder is decomposed and thus the mechanical strength of the electrode is reduced. Further, when the heating rate is excessively high, the electrode is rapidly contracted and thus a crack may occur.

After heat treatment of the precursor, in etching of the second nanoparticles, pores are formed in the porous structure by removing the second nanoparticles. The second nanoparticles may be removed by treating with an acid solution. That is, the pore size and porosity of the porous structure may be finally delicately controlled by etching the second nanoparticles.

Specifically, the acid solution may include, but is not limited to, hydrofluoric acid (HF) and at least one of methyl alcohol, ethyl alcohol, isopropyl alcohol, or any combination thereof.

Further, the concentration of the acid solution may range from about 1 wt % to about 20 wt %, and in this case, degassing of the acid solution using inert gas may be performed at a temperature of about 30° C. or lower. When the above range is not satisfied, the porous structure may be damaged by gas generated due to rapid etching reaction, or the first nanoparticles may be oxidized by dissolved oxygen and water.

That is, in the method for manufacturing the porous structure, the welding and etching processes are performed through the bottom-up approach and thus physical properties, such as conductivity and lithium affinity, of the porous structure may be adjusted, and not only microstructures, such as the porosity, pore size and surface area of an electrode but also macrostructures, such as the thickness and area of the electrode are delicately controlled. As a result, a pore size of hundreds of nanometers may be accurately implemented, or high porosity may be implemented.

Further, the pore size of hundreds of nanometer or high porosity of the porous structure may be implemented depending on the specific conditions of the manufacturing method of the porous structure. Some of the following descriptions may overlap with those described above, and a detailed description thereof will thus be omitted because it is considered to be unnecessary.

Specifically, the porous structure may include first nanoparticles and second nanoparticles, and may additionally include a binder.

Porosity of the porous structure may be adjusted by controlling the mass ratio of the first nanoparticles to the second nanoparticles in the above-described method for manufacturing the porous structure. Specifically, the porous structure may have porosity of about 30% to 90%, preferably about 50% to 90%. When the porosity of the porous structure for lithium batteries is excessively low beyond the above range, the weight of an electrode to the volume of lithium, which is capable of being stored, is excessively high, specific energy and energy density are reduced and, when the porosity of the porous structure for lithium batteries is excessively high, mechanical strength of the electrode is reduced.

Further, the pore size of the porous structure may be adjusted by controlling the size of the second nanoparticles. Specifically, the porous structure may have a pore size of about 30 nm to 5000 nm, preferably about 500 nm to 2000 nm. When the pore size is excessively small beyond the above range, ion penetration is slow and thus an amount of lithium electrodeposited on the surface of the porous structure increases and, when the pore size is excessively large, growth of lithium dendrites may not be suppressed and the surface area of the porous structure is reduced.

Further, the thickness of the porous structure may be adjusted through the calendaring process in the above-described method. Specifically, the porous structure may have a thickness of about 10 μm to 100 μm, preferably about 20 μm to 80 μm. When the thickness of the porous structure is excessively small beyond the above range, the electrode does not satisfy an areal capacity, which is required by secondary batteries, and, when the thickness of the porous structure is excessively large, the energy density of the electrode is reduced.

Therefore, the weight of the porous structure may be reduced to about 0.9 mg/cm² or less, preferably about 1.2 mg/cm² to 0.8 mg/cm², per 10 μm of the thickness of the porous structure.

Accordingly, a lithium battery may be manufactured by employing an anode comprising the porous structure and lithium metal disposed on the porous structure.

Here, the lithium battery may include the anode, a cathode, and an electrolyte interposed between the anode and the cathode.

First, the cathode may include a cathode active material, a binder, a conductive material, etc.

The cathode active material may include at least one selected from the group consisting of lithium cobalt oxide, lithium nickel cobalt manganese oxide, lithium nickel cobalt aluminum oxide, lithium iron phosphate oxide, lithium manganese oxide and combinations thereof. However, the cathode active material is not limited thereto, and any active material, which is usable in the field to which the present disclosure pertains, may be used.

The binder assists cohesion between the cathode active material and the conductive material and cohesion with a current collector, may include poly(vinylidene fluoride), polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene propylene diene terpolymer (EPDM), sulfonated EPDM, styrene butadiene rubber (SBR), fluoro-rubber, various copolymers, etc.

The conductive material may include any material which is conductive while not causing chemical change of the corresponding battery, without being limited thereto, and, for example, may include graphite, such as natural graphite or artificial graphite, a carbon-based material, such as carbon black, acetylene black, Ketjen black, channel black, furnace black, lamp black or summer black, conductive fiber, such as carbon fiber or metal fiber, metal powder, such as fluorinated carbon, aluminum or nickel powder, a conductive whisker, such as zinc oxide or potassium titanate, a conductive metal oxide, such as titanium oxide, or a conductive material, such as a polyphenylene derivative.

Further, the electrolyte conducts lithium ions between the anode and the cathode, and may include a liquid electrolyte, a lithium salt and an organic fluorine compound.

The liquid electrolyte may include an organic solvent which is usable in lithium secondary batteries without being limited thereto, and, for example, may include ethylene carbonate, dimethyl carbonate, diethyl carbonate, ethyl methyl carbonate, fluoroethylene carbonate, 1,2-dimethoxyethane, 1,2-diethoxyethane, dimethylene glycol dimethyl ether, trimethylene glycol dimethyl ether, triethylene glycol dimethyl ether, tetraethylene glycol dimethyl ether, polyethylene glycol dimethyl ether, succinonitrile, sulfolane, dimethyl sulfone, ethyl methyl sulfone, diethyl sulfone, adiponitrile, 1,1,2,2-tetrafluoroethyl-2,2,3,3-tetrafluoroethyl ether, dimethylacetamide or the like.

The lithium salt may include lithium salt which is usable in lithium secondary batteries without being limited thereto and, for example, may include LiNO₃, LiPF₆, LiBF₆, LiClO₄, LiCF₃SO₃, LiBr, Lil or the like.

The organic fluorine compound may be an additive which reacts with the lithium metal of the anode so as to form a protective layer. The organic fluorine compound spontaneously chemically reacts with the lithium metal so as to form the protective layer including lithium fluoride (LiF).

The organic fluorine compound may include a compound represented by Chemical Formula 1.

CF₃(CF₂)ₙ(CH₂)ₘX [Chemical Formula 1]

Wherein X may include, but is not limited to, at least one of Cl, Br, I, or any combination thereof, and 1≤n≤10 and 0≤m≤2 may be satisfied. Preferably, the organic fluorine compound may include CF₃(CF₂)₂I.

That is, the lithium battery includes the anode comprising the porous structure manufactured by the method described above, and may thus accurately implement a pore size of hundreds of nanometers or implement high porosity. And the lithium battery includes a proper amount of the binder in the porous structure, and may thus relatively reduce conductivity as compared to the conventional anodes and allow lithium to be electrodeposited within the porous structure during charging and discharging. As a result, growth of lithium dendrites and volume expansion of the anode may be suppressed.

Hereinafter, the present disclosure will be described in more detail through the following examples. The following preparation examples and examples serve merely to exemplarily describe the present disclosure, and are not intended to limit the scope of the disclosure.

### Preparation Example 1: Manufacture of Porous Structure for Lithium Batteries

Silica (SiO₂) nanoparticles, which are inorganic, having a particle size of 50 nm (prepared through the Stöber method) as second nanoparticles were added to copper nanoparticles, which are conductive, as first nanoparticles at a mass ratio of 1:1, and were mixed through ball milling. Thereafter, 10 wt % of a binder was mixed based on the total amount of a precursor, and a precursor sheet was prepared by calendaring the prepared precursor. Thereafter, the first nanoparticles were physically welded by heat-treating the precursor sheet to a temperature of 250° C. from room temperature at a heating rate of 25° C./min. Thereafter, a porous structure for lithium batteries having porosity of 91%, a pore size of 500 nm, a thickness of 80 μm and a weight of 7.0 mg/cm² was finally manufactured by removing silica (SiO₂) through etching using hydrofluoric acid (HF) as an acid solution.

### Preparation Example 2: Manufacture of Porous Structure for Lithium Batteries

A porous structure for lithium batteries having porosity of 68%, a pore size of 500 nm, a thickness of 80 μm and a weight of 23.2 mg/cm² was finally manufactured in the same manner as in Preparation Example 1, except that copper nanoparticles as first nanoparticles and silica (SiO₂) nanoparticles as second nanoparticles were mixed at a mass ratio of 1:0.5, as compared to Preparation Example 1.

### Comparative Preparation Example 2: Manufacture of Porous Structure for Lithium Batteries

A porous structure for lithium batteries having porosity of 35%, a pore size of 30 nm, a thickness of 80 μm and a weight of 53.9 mg/cm² was finally manufactured in the same manner as in Preparation Example 1, except that silica (SiO₂) nanoparticles, which are inorganic nanoparticles, as second nanoparticles were not used, as compared to Preparation Example 1.

### Example 1: Lithium Battery Manufactured Using Anode for Lithium Batteries Including Porous Structure for Lithium Batteries According to Manufacturing Example 1

An anode was prepared by electrodepositing lithium having a capacity of 1 mA h cm⁻² on the porous structure of Preparation Example 1. Further, a cathode comprising LiNi₅Co₂Mn₃, which is a cathode material, was prepared. Further, a separator, which is Celgard® 2500 was interposed between the anode and the cathode. Further, 1M LiPF₆ in EC:DEC+10 wt % FEC was prepared as an liquid electrolyte, and thereby, a lithium battery was finally manufactured.

### Comparative Example 1: Lithium Battery Manufactured Using Lithium Foil as Anode for Lithium Batteries

A lithium battery was manufactured in the same manner as in Example 1, except that lithium foil alone is used as an anode.

### Comparative Example 2: Lithium Battery Manufactured Using Copper Foil as Anode for Lithium Batteries

A lithium battery was manufactured in the same manner as in Example 1, except that copper foil alone is used as an anode.

### Comparative Example 3: Lithium Battery Manufactured Using Copper Mesh as Anode for Lithium Batteries

A lithium battery was manufactured in the same manner as in Example 1, except that a copper mesh alone is used as an anode.

### Test Example 1: Charge and Discharge Efficiency Analysis of Lithium Battery Anodes Depending on Whether or Not There Are Additional Nanoparticles

Stacks formed by stacking lithium having a thickness of 160 μm on the porous structures of Preparation Example 1 and Comparative Preparation Example 1 were used as counter electrodes and reference electrodes, the porous structures for lithium batteries were used as working electrodes, and charge and discharge efficiencies thereof were analyzed at a current density of 1 mA cm⁻².

Here, an electrolyte used in electrochemical analysis was manufactured by dissolving LiPF₆ salt in a solvent including ethylene carbonate (EC) and diethyl carbonate (DEC) at a volume ratio of 1:1 and 10 wt % of fluoroethylene carbonate (FEC) to form a 1M concentration.

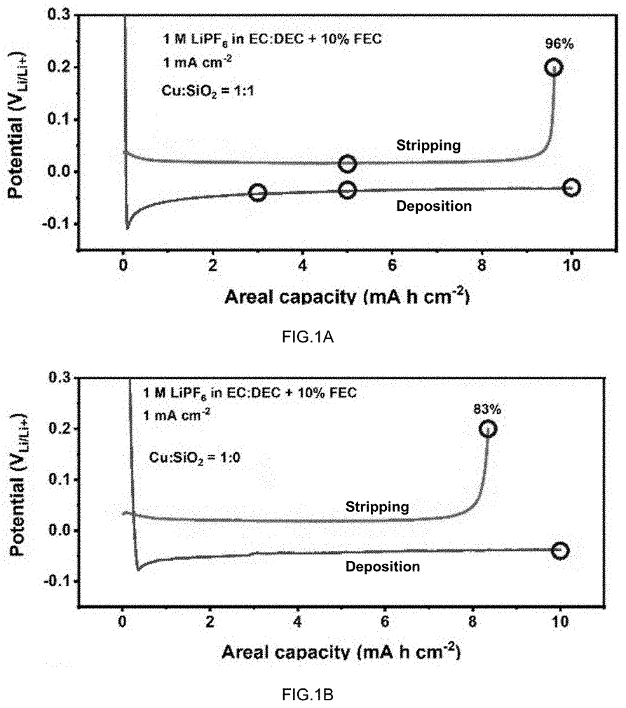

FIGS. 1A to 3B show charge and discharge efficiency analysis results and Scanning Electron Microscope (SEM) images of the porous structures.

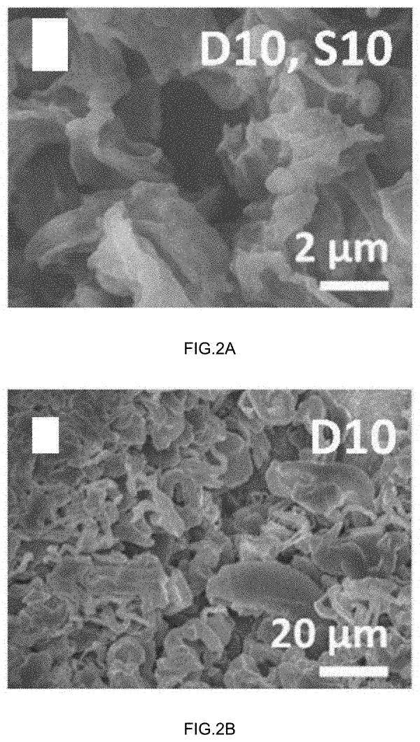

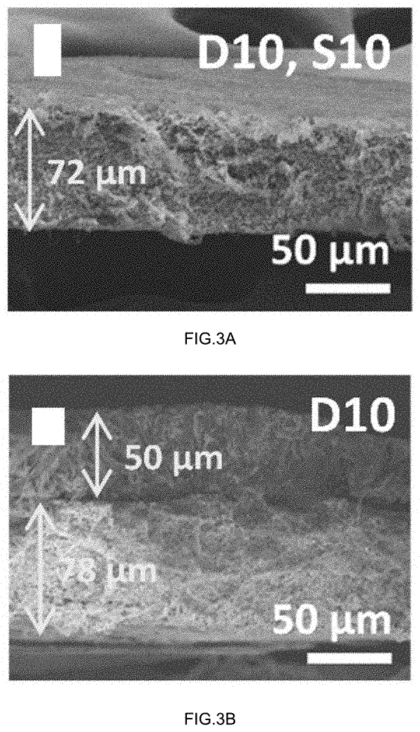

Specifically, FIGS. 1A and 1B show charge and discharge efficiency analysis results of the porous structures of Preparation Example 1 (FIG. 1A) and Comparative Preparation Example 1 (FIG. 1B), FIGS. 2A and 2B show Scanning Electron Microscope (SEM) images to the surface of the porous structures of Preparation Example 1 (FIG. 2A) and Comparative Preparation Example 1 (FIG. 2B) during charging and discharging, respectively. FIGS. 3A and 3B show SEM images to the cross-section of the porous structures of Preparation Example 1 (FIG. 3A) and Comparative Preparation Example 1 (FIG. 3B) during charging and discharging, respectively.

Referring to FIGS. 1A, 2A and 3A, it may be confirmed that, when the pore size and the porosity of the porous structure are sufficiently large and high, lithium may be deposited in the pores, coulombic efficiency of the porous structure may be increased and thus energy loss may be reduced, and the lifespan of a lithium battery may be improved.

On the other hand, referring to FIGS. 1B, 2B and 3B, it may be confirmed that, when the pore size and the porosity of the porous structure are small and low, lithium may not be deposited in the pores and is deposited on the surface of the porous structure, and coulombic efficiency of the porous structure is also low, i.e., 83%.

### Test Example 2: Coulombic Efficiency Analysis Depending on Pore Size and Porosity

Stacks formed by stacking lithium having a thickness of 160 μm on the porous structures of Preparation Example 1, Preparation Example 2 and Comparative Preparation Example 1 were used as counter electrodes and reference electrodes, the porous structures for lithium batteries were used as working electrodes, and coulombic efficiencies thereof were analyzed at a current density of 1 mA cm⁻².

Here, an electrolyte used in electrochemical analysis was manufactured by dissolving LiPF₆ salt in a solvent including ethylene carbonate (EC) and diethyl carbonate (DEC) at a volume ratio of 1:1 and 10 wt % of fluoroethylene carbonate (FEC) to form a 1M concentration.

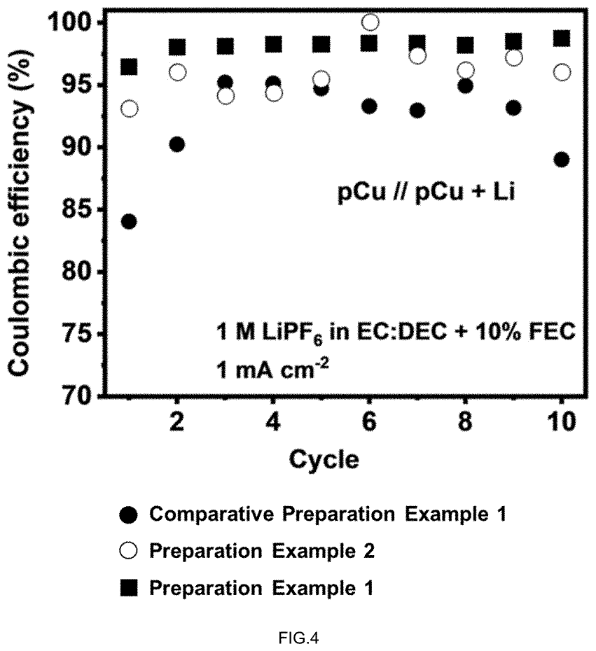

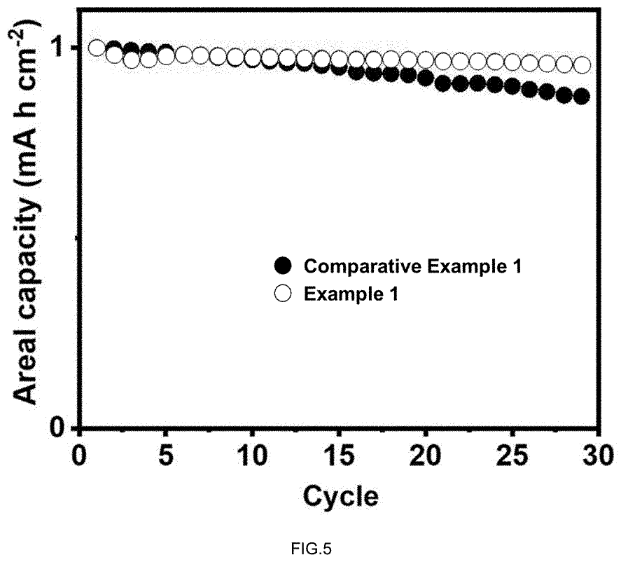

FIG. 4 shows Coulombic efficiency analysis results of the porous structures according to Preparation Example 1, Preparation Example 2 and Comparative Preparation Example 1.

Referring to FIG. 4, it may be confirmed that, as the pore size and the porosity of the porous structure are increased, the Coulombic efficiency of the porous structure is increased. Increase in the Coulombic efficiency may be resulted in improvement of the lifespan of a battery.

### Test Example 3: Analysis on Capacity Retention Rates of Conventional Anode and Anode using Porous Structure for Lithium Batteries and Whether or not Lithium is Electrodeposited on Anodes

The capacity retention rates of the lithium batteries according to Example 1 and Comparative Example 1 were measured after the lithium batteries have been charged and discharged at a current density of 1 mA cm⁻².

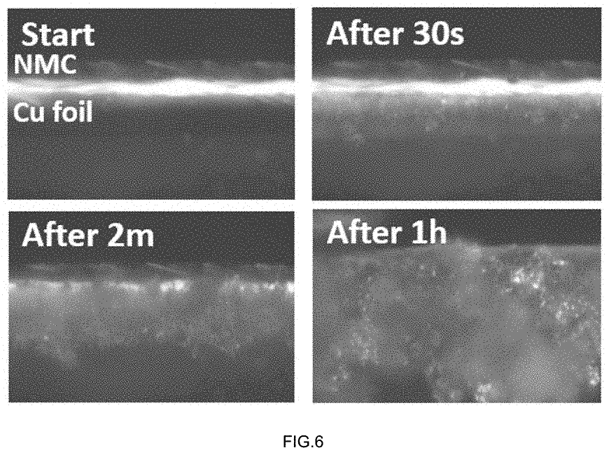

FIG. 5 shows the capacity retention rates of the lithium batteries according to Example 1 and Comparative Example 1, after the lithium batteries have been charged and discharged at a current density of 1 mA cm⁻².

Referring to FIG. 5, it may be confirmed that the capacity retention rate of the lithium battery according to Example 1 is improved.

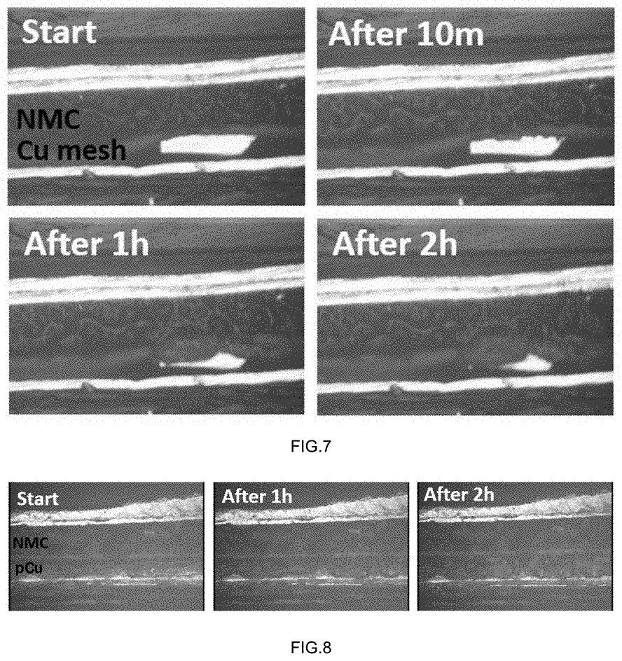

Further, FIGS. 6 to 8 are optical microscopic images showing degrees of electrodeposition of lithium in the lithium batteries according to Comparative Example 2 (FIG. 6), Comparative Example 3 (FIG. 7) and Example 1 (FIG. 8) depending on time, after the lithium batteries have been charged and discharged at a current density of 1 mA cm⁻².

First, referring to FIG. 6, it may be confirmed that, in the case of the lithium battery using the commercial copper foil having high conductivity as the anode, formation of lithium dendrites is clearly observed=. Further, referring to FIG. 7, it may be confirmed that, in the case of the lithium battery using the copper mesh having high conductivity as the anode, lithium electrodeposition on the surface of the copper mesh is predominant and thickness change of the anode is observed. On the other hand, referring to FIG. 8, it may be confirmed that, in the case of the lithium battery using the porous structure including copper having conductivity, which is artificially reduced by the binder, as the anode, thickness change of the anode is insignificant and lithium is electrodeposited within pores.

As the method of the present disclosure performs the welding and etching processes through the bottom-up approach, physical properties, such as conductivity and lithium affinity may be adjusted, and not only microstructures, such as the porosity, pore size and surface area of an electrode but also macrostructures, such as the thickness and area of the electrode, may be controlled. As a result, a pore size of hundreds of nanometers can be accurately implemented or high porosity can be implemented.

The anode for lithium batteries including the porous structure manufactured by the above-described method comprises a proper amount of the binder in the porous structure, and may thus relatively reduce conductivity as compared to the conventional anodes and allow lithium to be also electrodeposited within the porous structure during charging and discharging, thereby being capable of suppressing growth of lithium dendrites or suppressing change in the thickness of the anode due to induction of electrodeposition of lithium within the pores.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A method for manufacturing a porous structure for lithium batteries, the method comprising:
preparing a precursor by mixing first nanoparticles and second nanoparticles;
heat-treating the precursor; and
etching the second nanoparticles in the heat-treated precursor.

2. The method of claim 1, wherein the precursor further comprises a binder.

3. The method of claim 2, wherein an amount of the binder ranges from about 3 to about 50% by weight based on the total amount of the precursor.

4. The method of claim 1, further comprising producing a precursor sheet by calendaring the precursor, after the preparing the precursor.

5. The method of claim 1, wherein the first nanoparticles comprise at least one of a lithiophilic material, a conductive metal, or any combination thereof.

6. The method of claim 5, wherein the lithiophilic material comprises at least one of silver (Ag), zinc (Zn), gold (Au), aluminum (Al), magnesium (Mg), tin (Sn), silicon (Si), carbon (C), or any combination thereof.

7. The method of claim 5, wherein the conductive metal comprises at least one of copper (Cu), iron (Fe), titanium (Ti), nickel (Ni), or any combination thereof.

8. The method of claim 1, wherein a mass ratio of the first nanoparticles to the second nanoparticles ranges from about 1:0.3 to about 1:1.2.

9. The method of claim 1, wherein the second nanoparticles comprise at least one of organic nanoparticles, inorganic nanoparticles, or any combination thereof.

10. The method of claim 9, wherein the organic nanoparticles comprise at least one of poly(methyl methacrylate), polyethylene oxide, cellulose, polystyrene, or any combination thereof.

11. The method of claim 9, wherein the inorganic nanoparticles comprise at least one of silica (SiO₂), titania (TiO₂), zirconia (ZrO₂), alumina (Al₂O₃), or any combination thereof.

12. The method of claim 1, wherein, in the heat-treating the precursor, the precursor is heat-treated by raising the temperature from room temperature to about 240° C. to 260° C. at a rate of about 30° C./min or less so that the first nanoparticles are welded each other.

13. The method of claim 1, wherein, in the etching the second nanoparticles, the heat-treated precursor is treated with an acid solution to remove the second nanoparticles.

14. The method of claim 13, wherein the acid solution comprises hydrofluoric acid (HF) and at least one of methyl alcohol, ethyl alcohol, isopropyl alcohol or any combination thereof.

15. A porous structure for lithium batteries comprising first nanoparticles, wherein a porosity of the porous structure ranges from about 30% to about 90%.

16. The porous structure of claim 15, wherein a pore size of the porous structure ranges from about 300 nm to about 5000 nm.

17. The porous structure of claim 15, wherein a thickness of the porous structure ranges from about 10 μm and about 100 μm.

18. An anode for lithium batteries comprising the porous structure of claim 15 and lithium metal disposed on the porous structure.

19. A lithium battery comprising the anode of claim 18.
